(19) United States
(12) Patent Application Publication
(10) Pub. No.: US 2005/0205744 A1
(43) Pub. Date: Sep. 22, 2005

(54) Attachment device for an object, such as a cutting board

(76) Inventor: Parmjit Singh, Dragoer (DK)

Correspondence Address: Harpman & Harpman, 819 Southwestern Run, Youngstown, OH, 44514, US

(21) Appl. No.: 11/065,925

(22) Filed: Feb. 25, 2005

(30) Foreign Application Priority Data
Oct. 31, 2002 (DK) PA 2002 01656
Sep. 2, 2003 (DK) PA 2003 01248

(51) Int. Cl. B23Q 1/00; A47F 5/00

(52) U.S. Cl. 248/351; 248/205.5

(57) ABSTRACT

An attachment device for removably securing an object, such as a cutting board (18) having an upper and lower side, to a kitchen table and has a plurality of depressions (17) on its lower side where each depression accommodates a suction cup (12) which is optionally attached resiliently, whereby the suction cups, after having been attached to the table are concealed completely or partly in the depressions, and such that the lower side of the cutting board optionally contacts the kitchen table.

The attachment device is formed by a bushing (1) screwed into each of the depressions (17) and having internal (2) and external (3) threads, where the internal threads can receive a nut (11) having external threads (10) so as to provide a space (8) with a hole (9) in which a screw (4) may be moved under the action of a spring (7) surrounding the screw. The free end of the screw is provided with threads (5) into which the suction cup (12) may be screwed.

When the cutting board (18) is lifted from the table and lowered toward the table, the suction cup (12), after having being sucked to the table, will move into the depression (17), whereby the lower side of the cutting board contacts the kitchen table. It is ensured hereby that the cutting board is held stably on the table without tilting, while all the forces on the upper side of the cutting table will be transferred to the kitchen table, as the lower side of the cutting board is in contact with the kitchen table.

It is a further embodiment; the cutting board has an awl (35) on its upper side to retain e.g. a piece of meat.

### BACKGROUND OF THE INVENTION

1. Field of the Invention

The invention relates to an attachment device for an object, such as a cutting board, to a substrate, such as a kitchen table, said object having an upper and a lower side, said attachment device being formed by a plurality of suction cups which are attached to the lower side, said suction cups each consisting of an elastic part and a screw part.

In connection with work in the kitchen, where e.g. pieces of meat placed on a cutting board are cut, it is quite usual that the cutting board in use slides on the kitchen table, which may e.g. be caused by the fat which is inevitably present in connection with the processing of meat.

2. Description of Prior Art

This is inexpedient, since, in addition to disturbing the actual processing operation, it may mean that the user cuts himself on the kitchen utensils, as the work with these may bet out of control, if the cutting board of a piece of meat slides on the kitchen table or on the cutting board. U.S. Pat. No. 5,326,086 discloses a cutting rack having in its ends suction cups that fixes the cutting rack to a supporting surface and permits a user to pivot the cutting rack in a horizontal plane.

### SUMMARY OF THE INVENTION

Accordingly, an object of the invention is to provide an attachment device of the type defined in the introductory portion of claim 1, where it is ensured that an object, such as a cutting board used for the processing of food is retained under conditions where the substrate on which the cutting board is placed is smooth.

The object of the invention is achieved by an attachment device of the type defined in the introductory portion of claim 1, which is characterized in that the suction cups are attached in depressions in the lower side and that the suction cups are movable into said depressions, and when the lower side is moved down against the substrate, the suction cups will enter into the depressions and be attached to the substrate.

To improve the attachment device additionally, and without any risk of tilting of the cutting board, it is an advantage if, as stated in claim 2, the suction cups will enter so deep into the depressions that the lower side rests against the substrate.

Hereby, forces intended to prevent the cutting board from being moved will be ensured by the suction cups, while other forces, e.g. from cutting actions, are transferred from the lower side of the cutting board to the substrate on which it rests, which has the additional advantage that the cutting board cannot tilt in operation.

In order that the suction cups do not seem loose when they are not supported against a substrate, it is an advantage if, as stated in claim 3, the suction cups are attached resiliently in the depressions.

A practical and expedient embodiment of the attachment device according to the invention is, as stated in claim 4, that the suction cups are attached in a bushing having internal and external threads, where the external threads are screwed into a depression in the object, and where a nut having external threads may be screwed into the internal threads, and that a space is provided between the bushing and the nut in which a screw surrounded by a spring is positioned.

As stated in claim 5, when the suction cup has internal threads which cooperate with external threads, it is easy to remove the suction cup with a view to cleaning or exchange.

To ensure that the suction cups may be loosened in a simple manner from the substrate on which they are held by suction, it is an advantage if, as stated in claim 6, that one end of a wire is attached to the surface of the suction cup, while the other end of the wire is attached to the object in or near the depression.

When the cutting board is lifted from the table, the suction cups will hereby be loosened from the substrate, as the wire will pull the edge of the suction cup which will hereby be “punctured”.

To stabilize the entire attachment device according to the invention additionally, it is an advantage if, as stated in claim 7, the head of the screw is formed with a projection which engages with a groove formed in the nut.

A particularly expedient way of releasing the suction cups from the substrate is characterized, as stated in claim 8, in that a cavity of a bushing accommodates a release arrangement consisting of a cap, whose one surface has attached thereto a spring which is attached to a sealing ring at its opposite end, and where the cavity additionally accommodates a nut in which one end of a cylinder having a through hole is attached, and where the opposite end of the cylinder is attached to the suction cup, and that the cylinder is surrounded by a second spring.

To make the cutting board additionally easy to use, it is expedient if, as stated in claim 9, the upper side of the object is formed with at least one hole which is adapted to receive a nut having a four-edged hole, and, as stated in claim 10, that the four-edged hole accommodates a holding means which is formed by an awl.

It is hereby possible to handle the processing of pieces of meat with great safety, since both the cutting board and the pieces of meat are held stably, also when the user works with a kitchen utensil, such as a knife or a meat cleaver.

Finally, to additionally enhance the flexibility of the cutting board with the attachment device and the holding means according to the invention, it is an advantage if, as stated in claim 11, one of the edges of the object is formed with a depression to receive the holding means, and, as stated in claim 12, that the depression is terminated by a cap or the like.

### DESCRIPTION OF THE DRAWINGS

FIG. 1 is an exploded view for the attachment of suction cups in a cutting board;

FIG. 2 shows a cutting board with a mounted suction cup;

FIG. 3 is an exploded view of an embodiment of a release mechanism for the suction cup;

FIG. 4 is a top view of an additional attachment device according to the invention;

FIG. 5 is a sectional view of the attachment device of FIG. 4;

FIG. 6 shows a holding means according to the invention; and

FIG. 7 shows the holding means in a situation of storage.

### DETAILED DESCRIPTION OF THE INVENTION

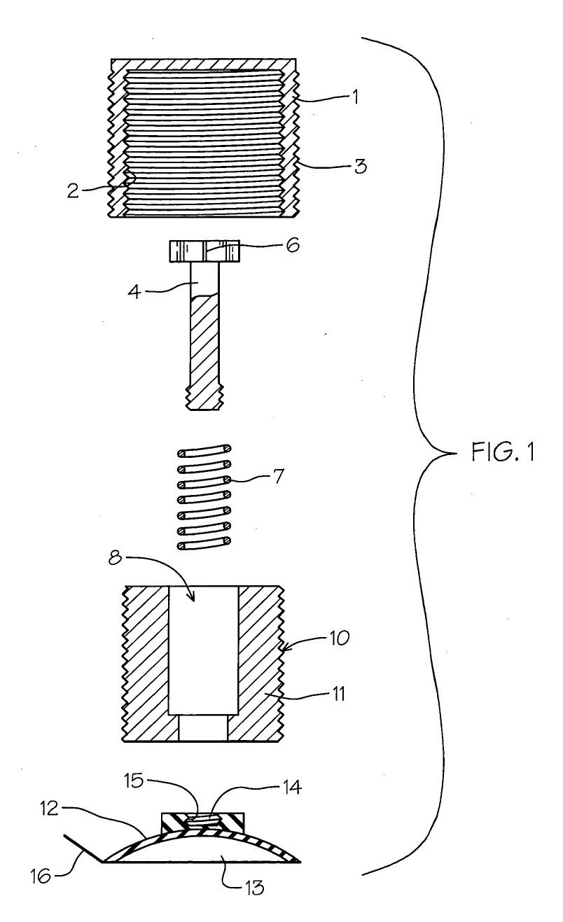

FIG. 1 shows a bushing 1 having internal threads 2 and external threads 3. A nut 11 having external threads 10 may be screwed into the internal threads 2 of a bushing 1. A screw 4 may be arranged in a space 8 defined by the bushing 1 and the nut 11, said screw being surrounded by a spring 7 such that the screw 4, which has external threads at its free end, may be passed out through the opening 9 of the nut. The head of the screw is formed with a projection as shown at 6.

FIG. 1 additionally shows a suction cup 12 having a suction space 13, as well as a wire 16, whose function will be described later. A screw part having a depression 14 and internal threads 15 is arranged on the suction cup 12.

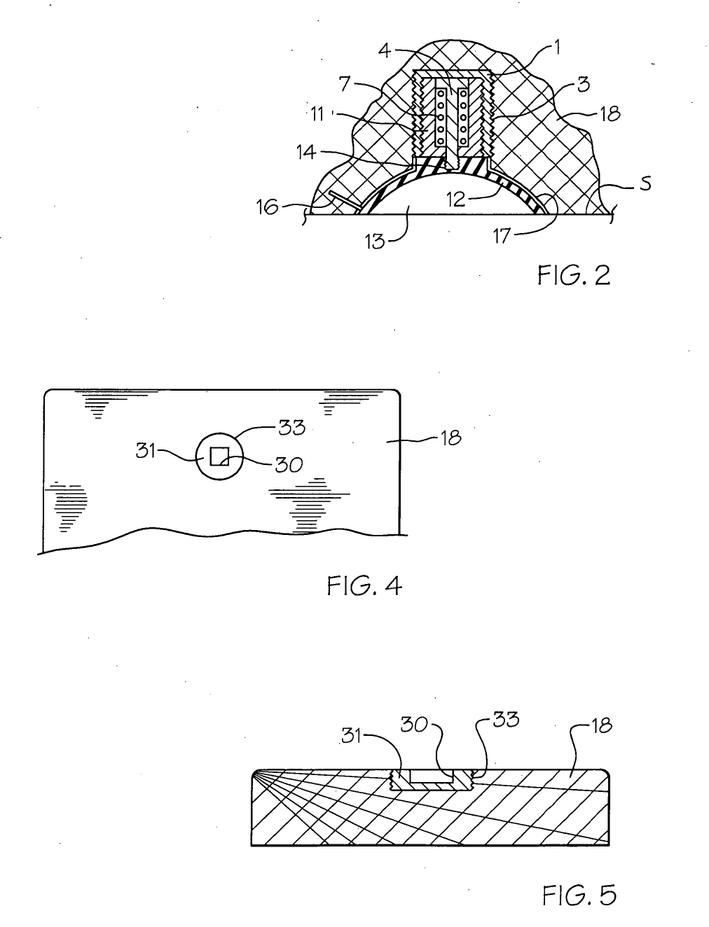

The parts in FIG. 1 may be assembled as shown in FIG. 2 where the attachment device is used in connection with a cutting board 18.

As will be seen in FIG. 2, the wire 16 is attached to the cutting board 18 at an attachment point 16 in a depression 17 formed in the cutting board 18.

The projection 6 is intended to prevent rotation of the screw 4 in the nut 11, whose inner side is formed with a groove (not shown) which can receive the projection.

The function of the attachment device shown in FIGS. 1 and 2 will now be explained more fully. The suction cup can assume three different positions which are related to rest position, support against a substrate and release from a substrate.

In the rest position, which may e.g. be the case when the cutting board is placed on edge, the screw 4 is pressed upward into the cavity 8 by the action of the spring 7, whereby the suction cup 12 will be pressed against the lower face of the nut in the area around the depression 14.

It should be noted, however, that the spring 7 is not absolutely necessary for the functionality of the cutting board, but that it is extremely expedient that it is used.

The decisive feature is thus that the suction cup 12 may be moved relative to the cutting board.

When the suction cup 12 is pressed against a substrate, the elastic parts of the suction cup 12 i.e. the area surrounding the central part of the suction cup 12 i.e. around the part where the depression is provided, will be pressed entirely or partly into the depression 17 so that the lower side of the cutting board 18 is either at a small distance from or supports against the substrate. However, it is preferred that the lower side rests against the substrate.

When the suction cup 12 is to be released from the substrate S, the screw 4 will be moved out of the hole 9, whereby the spring 7 will be compressed. Since the screw 4 is attached to the suction cut 12, a force will be applied to the suction cut 12 which will release it from the substrate, and when the suction cup 12 has been released from the substrate S the spring force will move the screw 4 and thereby the suction cup 12 back to the rest position.

As will be explained below, it is expedient if a release mechanism is provided for the release of the suction cup 12.

In a first embodiment, the release mechanism is formed as part of the wire 16 as it will cause the suction cup 12 to be “punctured” and thereby loosened, since the wire 16 will apply a pull at the outer rim of the suction cup, as the wire is attached in the depression 17 at its one end which is moved relative to the suction cup during the release thereof.

Finally, it is noted that if multiple suction cups 12 when arranged on a kitchen table, are moved completely into the depressions 17, then all forces from the upper side of the cutting board 18 will be transferred to the lower side of the cutting board, which will thereby maintain stability and e.g. will not tilt on the surface.

In other words, the suction cups 12 will only absorb forces that extend in parallel with the upper and lower sides of the cutting board 18.

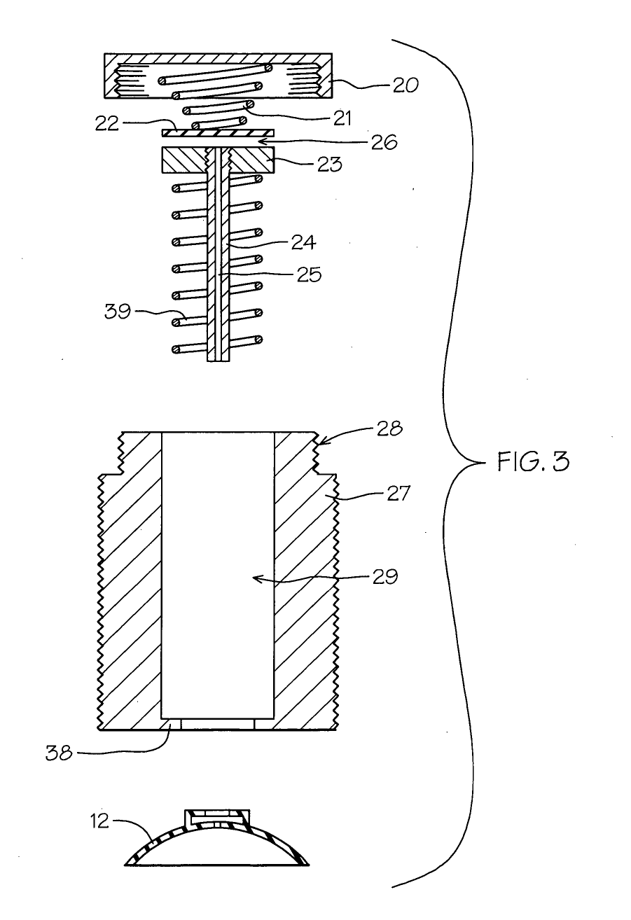

FIG. 3 shows the structure of an alternate release mechanism relative to the wire solution explained above.

In FIG. 3, the numeral 27 designates a bushing with a cavity 29 corresponding to the bushing 11 in FIG. 1, but changed such that it has a smaller diameter at its upper end, shown at 28. A cap 20 may be attached to this upper end e.g. by screwing. A spring 21 is attached to the lower side of the cap 20 and is attached at its opposite end to a sealing ring 22.

Further, the cavity 29 of the bushing 27 accommodates a nut 23 which is connected with the suction cup 13 via a cylinder 24 having a through hole 25.

A second spring 39 surrounding the cylinder 24 is interposed between the suction cup 13 and the nut 23. The end of the spring 39 closest to the suction cup engages with an inner stop 38 in the bushing 27.

The function of the release mechanism will be explained now. When the cutting board 18 is placed on a table (not shown), the suction cup 12 is disposed inside the depression 17 as shown in FIG. 2. In this state, one surface of the sealing ring 22 intimately engages with the nut 23 because of the forces exerted by the two springs 21 and 39.

If the cutting board is now raised from the table, a pull will be applied to the nut 23, thereby creating a gap 26 between the seal 22 and the nut 23 which communicates with the hole 25 and the inner surface of the suction cup 12.

Since a negative pressure prevails in the suction cup when it is held against the table, air will now be allowed to flow via the gap 26 and the hole 25 so that the suction cup will loosen from the table.

With reference to FIGS. 4-7, the numeral 18 designates a cutting board whose upper side has a pre-drilled hole intended to receive a nut 31 having external threads 33.

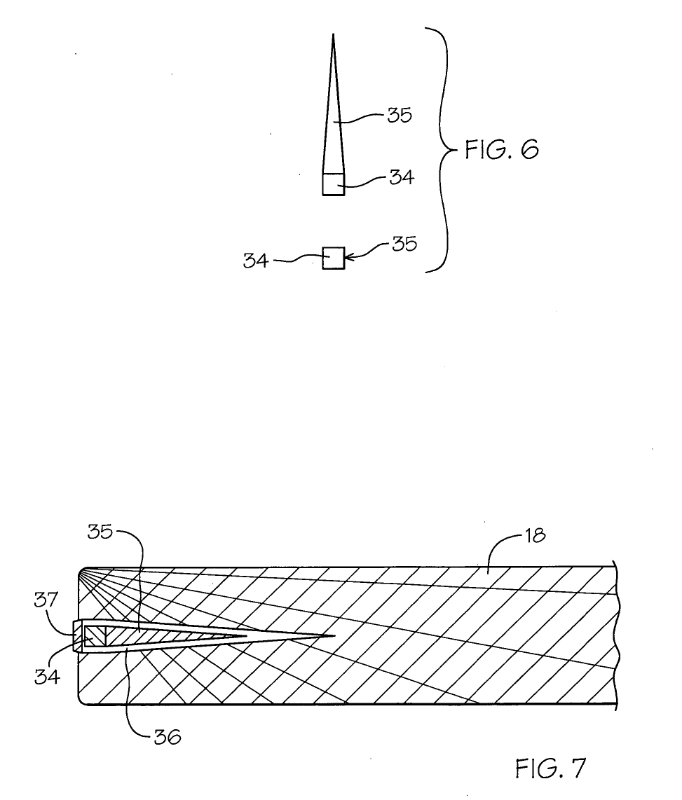

As will be seen, the nut is formed with a four-edged hole 30 in which the holding means 35 shown in FIG. 6 may be received. As will be seen, the holding means is terminated at one end by a four-edged part 34 which has the same or slightly larger dimensions than the hole 30.

The holding means may now be placed in the hole 30 in the nut 31 on the upper side of the cutting board and there serve the retain e.g. pieces of meat, which is an advantage to a user since he can hold part of the piece of meat by one hand, and since the holding means holds another part of the piece of meat, it is possible for the user to work with a kitchen utensil, such as a knife, with his other hand.

It is noted in this connection that precisely because the cutting board is provided with suction cuts, stable handle and processing of pieces of meat are ensured, without any risk of the cutting board sliding on its surface, and with full control in the use of kitchen utensils, since the meat to be processed cannot slide on the cutting board either.

For the cutting board to be used for the processing of foods where the holding means 35 is not necessary, a side edge of the cutting board 18 is formed with a bore 36 in which the holding means 35 may be stored. After the holding means has been placed in the bore 36, the bore may be closed by a cp 37 or the like.

Although the invention has been specifically explained in connection with cutting boards, nothing prevents the principles from being used in other connections within the scope defined by the claims, where objects are to be attached in a manner such that they do not slide, and such that it is ensured that forces applied perpendicularly to the objects cannot be transferred to the attachment device of the objects.

1. An attachment device for an object, such as a cutting board (18), to a substrate, such as a kitchen table, said object having an upper and a lower side, said attachment device being formed by a plurality of suction cups (12) which are attached to the lower side, said suction cups each consisting of an elastic part and a screw part, characterized in that the suction cups are attached in depressions in the lower side and that the suction cups are movable into said depressions, and when the lower side is moved down against the substrate, the suction cups will enter into the depressions and be attached to the substrate.

2. An attachment device according to claim 1 characterized in that the suction cups will enter so deep into the depressions that the lower side rests against the substrate.

3. An attachment device according to claim 1 characterized in that the suction cups are attached resiliently in the depressions (17).

4. An attachment device according to claim 1 characterized in that the suction cups (12) are attached in a bushing (1) having internal (2) and external (3) threads, where the external threads are screwed into a depression in the object, and where a nut (11) having external threads (10) may be screwed into the internal (2) threads, and that a space (8) is provided between the busing (1) and the nut (11) in which a screw (4) surrounded by a spring (7) is positioned.

5. An attachment device according to claim 1 characterized in that the suction cup (12) has internal threads (15) which cooperate with external threads (5) on the screw (4).

6. An attachment device according to claim 1 characterized in that the one end of a wire (16) is attached to the surface of the suction cup, while the other end of the wire is attached to the object in or near the depression.

7. An attachment device according to claim 1 characterized in that the head of the screw (4) is formed with a projection (6) which engages with a groove formed in the nut (11).

8. An attachment device according to claim 1, characterized in that a cavity (29) of a bushing (27) accommodates a release arrangement consisting of a cap (20) whose one surface has attached thereto a spring (21), which is attached to a sealing ring (22) at its opposite end, and where the cavity additionally accommodates a nut (23) in whish one end of a cylinder (24) having a through hole (25) is attached, and where the opposite end of the cylinder (24) is attached to the suction cup (13) and. that the cylinder (24) is surrounded by a second spring (39).

9. An attachment device according to claim 1 characterized in that the upper side of the object is formed with at least one hole which is adapted to receive a nut (31) having a four-edged hole (30).

10. An attachment device according to claim 9, characterized in that the four-edged hole (30) accommodates a holding means which is formed by an awl (35).

11. An attachment device according to claim 10, characterized in that one of the edges of the object is formed with a depression (36) to receive the holding means (35).

12. An attachment device according to claim 11, characterized in that the depression (36) is terminated by a cap (37) or the like.
